(19) United States
(12) Patent Application Publication
(10) Pub. No.: US 2015/0047137 A1
(43) Pub. Date: Feb. 19, 2015

(54) Multi-segment cleaning device

(71) Applicant: International Tobacco Machinery Poland Sp.zo.o., Radom (PL)

(72) Inventor: Adam Gielniewski, Radom (PL)

(21) Appl. No.: 14/334,720

(22) Filed: Jul. 18, 2014

(30) Foreign Application Priority Data
Aug. 13, 2013 (PL) P.405057

(51) Int. Cl. B08B 9/043

(52) U.S. Cl. CPC B08B 9/0436
USPC 15/104.05

(57) ABSTRACT

A multi-segment cleaning device used in the tobacco industry to clean the channels transporting rod-shaped articles, comprising at least two cleaning members (20, 30) characterised in that at least one of the cleaning members (30) is made of a material ensuring a greater deformation of a cleaning member (30) contacting the wall (51, 52) of the transport channel (50) that the deformation of a cleaning member (20) contacting, at the same point, the wall (51, 52) of the transport channel (50).

The object of the invention is a multi-segment cleaning device used in the tobacco industry.

### BACKGROUND

A problem in the operation of installations in the tobacco industry is efficient and effective splitting of product brands. The transport channels for the mass flow of such products as cigarettes, filter rods, cigars or cigarillos are often very complex and in addition run in different directions, also vertically, above the operational stands and transport lines for operators operating these stands. The access to the beginning and the end of each section of transport channels, which require cleaning to remove the products when changing the product brand, is often difficult and takes time in each case. The access to connection zones of transporters forming a channel, which are susceptible to deposition of products, is also difficult.

That is why systematic cleaning of installations used in the tobacco industry is a routine practice. Moreover, cleaning is required each time before a change of the product brand—this activity was introduced for technological reasons, i.e. the removal of all products coming from preceding production.

A standard solution known in the state of the art is the stoppage of the production line, manual or automatic leading-in into the installation channel of a multi-segment cleaning member, e.g. a sponge filling the channel in its cross-section, and start-up of the installation with simultaneous observation of the movement of the cleaning member along the installation, then another stoppage of the installation and removal of the cleaning member at the other end of installation being cleaned or at the receiving station.

A drawback of the known solution emerges during the cleaning of vertical or complex-shaped channels. Multi-segment cleaning devices either jam when squeezing through sharp bends of the transport channel or slide down in vertical channels in a situation where the transport channel widens and the cleaning device loses the support in one of the walls.

Multi-segment cleaning devices used in transport channels of transport lines conveying rod-shaped articles are known in the state of the art.

A multi-segment cleaning device whose members are made of an elastic material is known from the international patent application WO 2011/136670. This device is led in into and out of the channel by means of an automatic docking station.

The European patent application EP 1 712 141 A2 presented a cleaning device made of joined cells which is transferred in the transport channels. The design of the device allows transferring it at the angle of 90° whereas the cleaning and guiding members are made of dimensionally stable elastic plastic foam.

The U.S. Pat. No. 5,316,122 presented a slide to be guided in transport channels. The slide is guided by means of conveyors; in a top view the slide has the form of oblong rectangle. According to the patent, the slide is made of cells joined by spherical joints so that it can deflect in the plane of the transport channel as well as in the direction perpendicular to that plane.

### SUMMARY OF THE INVENTION

The object of the invention is a multi-segment cleaning device used in the tobacco industry to clean channels transporting rod-shaped articles, comprising at least two cleaning members. A device according to the invention is characterised in that at least one of the cleaning members is made of a material ensuring a greater deformation of the member contacting the wall of the transport channel than the deformation of a second cleaning member contacting, at the same point, the wall of the transport channel.

Furthermore, a device according to the invention is characterised in that at least one of the cleaning members is a member with increased deadweight relative to a second cleaning member.

Furthermore, a device according to the invention is characterised in that a cleaning member comprises a core enclosed by a material ensuring the deformation of a cleaning member.

Furthermore, a device according to the invention is characterised in that a cleaning member comprises an external casing enclosing the filling material, ensuring the deformation of a cleaning member.

Furthermore, a device according to the invention is characterised in that a cleaning member has a weight greater by at least 50% than the weight of a second cleaning member, preferably a weight greater by 100% than the weight of a second cleaning member.

Furthermore, a device according to the invention is characterised in that a cleaning member deforms so that when adhering to the wall of the transport channel the contact surface of a cleaning member is greater by at least 30% than the contact surface of a second cleaning member, at the same point of the transport channel. Preferably, the contact surface is greater by 100% than the contact surface of a second cleaning member.

Furthermore, a device according to the invention is characterised in that the core of a cleaning member is made of a material selected from a group comprising in particular metals, plastics, wood.

Furthermore, a device according to the invention is characterised in that a cleaning member is filled with an amorphous material selected from a group comprising in particular granules, powders, gels, liquids.

Furthermore, a device according to the invention is characterised in that cleaning members are alternately connected, along the direction of transport, one after another, by means of a connecting member so that they can deflect in at least one direction relative to one another.

Furthermore, a device according to the invention is characterised in that extreme members are second cleaning members.

Furthermore, a device according to the invention is characterised in that cleaning members are separated by a distance piece.

Furthermore, a device according to the invention is characterised in that extreme cleaning members are, in addition, provided with detection markers.

Furthermore, a device according to the invention is characterised in that in addition it is provided with an elastic member that cooperates with a connecting member so that it reduces the stresses of the connecting member.

Due to increased elasticity of the cleaning members, a device according to the invention adheres with a greater surface to the walls of the transport channel so that it does not slide down in vertical channels, and it is also possible to lead it through channels with a complex shape. In addition, the effect of adherence to the walls increases due to the lead-in of members with increased weight; this allows free guiding of the cleaning device in channels with a complex shape where the increased weight ensures stable guiding of the device.

### DESCRIPTION OF THE DRAWING

The object of invention has been shown in detail in a preferred embodiment in a drawing in which:

FIG. 1 diagrammatically shows a cleaning device according to the invention;

FIG. 2 shows a section of a cleaning device according to the invention;

FIG. 3 shows a section of another embodiment of a cleaning device according to the invention;

FIG. 4 shows a cleaning device according to the invention in a vertical transport channel;

FIG. 5 shows, in enlargement, two members of a cleaning device in a vertical transport channel;

FIG. 6 shows a cleaning device moving along a path in a multilayer system of transport channels; and

FIG. 7 shows a cleaning device moving inside a channel in a multilayer system of transport channels.

### DETAILED DESCRIPTION

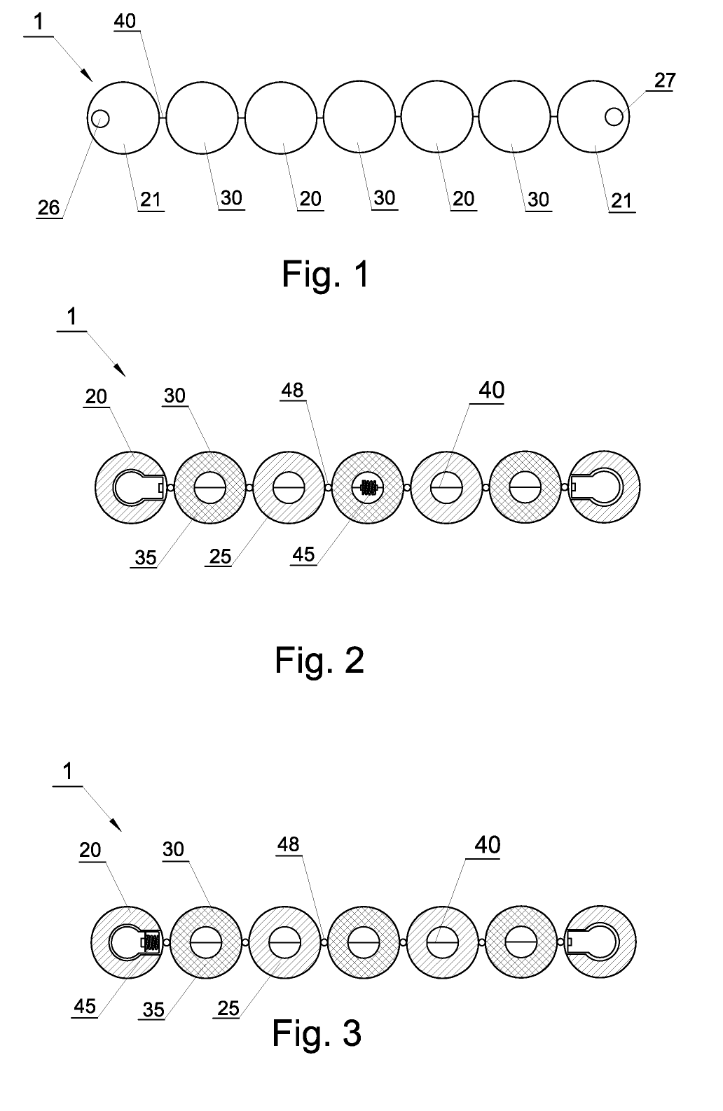

FIG. 1 shows a preferred embodiment of a cleaning device 1 according to the invention in a side view. A cleaning device is provided with extreme cleaning members 21 on which detection markers 26, 27 have been placed; in addition, it is provided with internal first and second cleaning members 20 and 30 having different physical properties so that they can ensure different surfaces of adherence of the cleaning members 20 and 30 to the walls of the transport channel. In a preferred embodiment of the invention the second members 20 are characterised in that they adhere to the walls of the transport channel over a smaller surface. These are usually members made of sponge with a core made of plastic. The first members 30 are more plastic, they may be made of various plastics or natural plastics, preferably they have the form of a jacket in a material casing enclosing the core of plastic. The term “plastic” is to be understood as the possibility of temporary surface deformation imaging the shape of the surface of the transport channel. In other words, the surface of the member 30 substantially takes the shape of the channel surface, for example of small projections and any surface breaks.

FIG. 2 shows a section of an embodiment of a cleaning device according to the invention. A cleaning device 1 is made of seven alternately disposed cleaning members 20, 30. All cleaning members 20, 30 are mounted on a connector 40 which is anchored in the extreme cleaning members. The connector 40 comprises a compensating member 45 disposed in the central part, as shown in FIG. 2. However, a different location of a compensating member 45, for example at the ends of the connector 40 as shown in FIG. 3, is possible. The compensating member may be a spring or an insert of a material with a greater elasticity, e.g. rubber with increased strength which is more elastic than a steel cable or a chain made of polyethylene. The function of a compensating member is to adjust the distance between the members of a cleaning device when squeezing through complicated transport channels, for example at the curves of the transport channels.

A connector 40 preferably has the form of a steel cable. Furthermore, between cleaning members 20, 30 at the connector 40, separators 48 maintaining the distance between the cleaning members 20, 30 are disposed.

FIGS. 2 and 3 diagrammatically show a different filling 25, 35, respectively, of the cleaning members 20 and 30. According to the invention, the second cleaning members 20 are less plastic than the first cleaning members 30. The cleaning members 30 may be made of various plastics or natural plastics; preferably they have the form of a jacket in a material casing enclosing a core of plastic, wood or metal. A material casing may be made of such material as polyester, or have the form of a rubber or rubberised coating, preferably the casing is made of a fabric. Generally, it should be made of a material allowing lining of the irregularities of the surface of the transport channels.

A jacket of a cleaning member is preferably filled with an amorphous material 35, e.g. polycarbonate granules, natural granules; it may have the form of a silicone filling or a gel. Such filling gives the cleaning member the desired physical properties, i.e. allows adjusting the shape of the cleaning member to the surfaces of the walls 51, 52 of the transport channel 50 and the transport belt. Furthermore, the possibility of using various fillings allows adjusting the weight of the first cleaning members 30. Alternatively, the first cleaning members 30 may be made of an elastic coating identical to the coating applied in the second cleaning members 20, but with the difference that they have a heavier core. This allows obtaining a greater contact surface with the walls of the transport channel. Preferably, the weight of the first cleaning member 30 is at least 50% greater than the weight of the second cleaning member 20, preferably 100% greater. A greater weight allows overcoming the stiffness of the outer coating protecting a jacket 35 of the first cleaning member 30 and increasing the contact surface of the first cleaning member 30 with the wall of the transport channel.

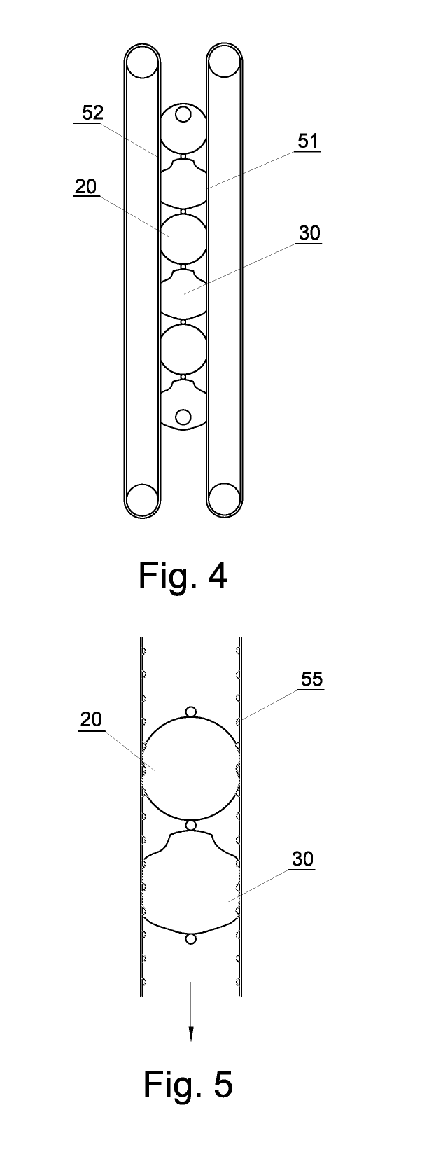

FIG. 4 shows the cleaning device in a vertical transport channel. In FIG. 4, the difference in the behaviour of first and second cleaning members 20 and 30 can be seen. The first members 30 contact the walls of the transport channel over a greater surface. During the tests, it was unexpectedly noticed that the preferred effect of holding the cleaning device in a vertical transport channel was obtained when the contact surface of the members 30 was at least 30% greater that the contact surface of the second cleaning members 20, preferably 100% greater than the contact surface of the second cleaning member 20.

Furthermore, as shown in FIG. 5, it should be noted that the walls of the transport channel are provided with small projections 55 which increase the effect of holding so that the device does not spontaneously slide down under the action of the force of gravity. Furthermore, the walls of the transport channel may be made of stainless steel or polyethylene.

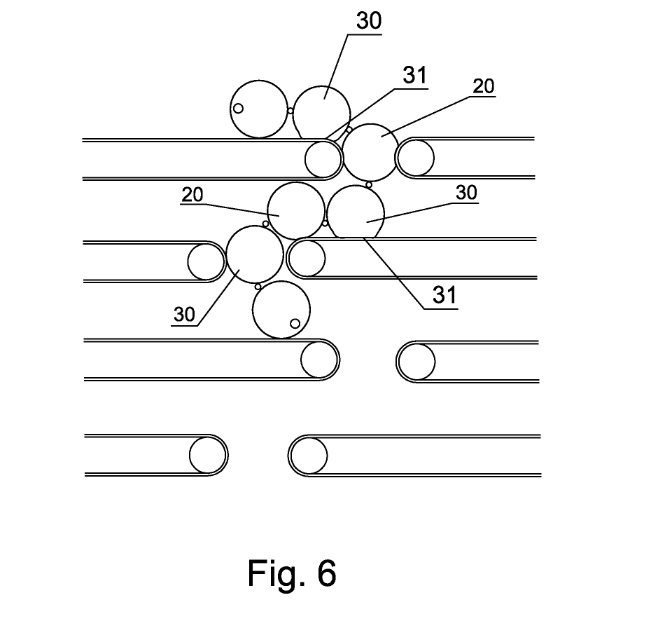

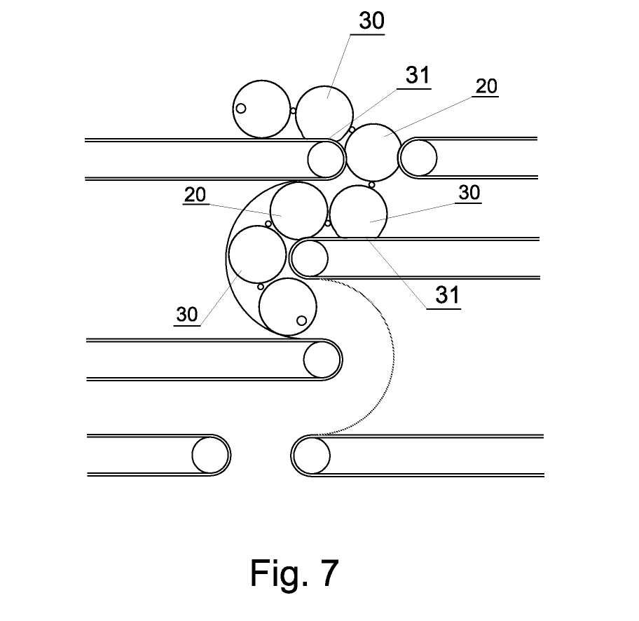

FIG. 6 shows another type of the vertical transport channel in which the cleaning device is moved among the particular levels of a complex multi-layered transport system. During the research works, it was unexpectedly found that the preferable effect of holding the cleaning device may be increased by differentiating the weight of particular cleaning members. An increased weight in connection with a greater plasticity of the jacket of the first members 30 causes that they adhere over a greater surface to the walls of the transport channel. The contact surface 31 of a cleaning member together with an increased weight of the first members 30 allows holding the cleaning device which does not fall down and does not slide down the complex path of the transport channel. FIG. 7 shows another type of the channel in which the cleaning device may be used. The cleaning device squeezes through the shown arched channels in such a way that the guiding part of the device is held on one horizontal transporter, and the back part of the device is held on another horizontal transporter situated above.

1. A multi-segment cleaning device used in the tobacco industry to clean channels transporting rod-shaped articles, comprising at least two cleaning members (20, 30) having different physical properties characterised in that at least one of the cleaning members (30) is made of a material ensuring a greater deformation of a first cleaning member (30) contacting a wall (51, 52) of the transport channel (50) than the deformation of a second cleaning member (20) contacting, at the same point, the wall (51, 52) of the transport channel (50).

2. The device as in claim 1 characterised in that at least one of the cleaning members (30) is a first member having increased weight relative to the second cleaning member (20).

3. The device as in claim 2 characterised in that the first cleaning member (30) comprises a core enclosed with a material ensuring the deformation of the first cleaning member (30).

4. The device as in claim 1 characterised in that the first cleaning member comprises an outer shield enclosing the filling material ensuring the deformation of the first cleaning member (30).

5. The device as in claim 1 characterised in that the first cleaning member (30) has a weight greater at least by 50% than the weight of the second cleaning member (20), preferably a weight greater by 100% than the weight of the second cleaning member (20).

6. The device as in claim 1 characterised in that the first cleaning member (30) deforms so that when adhering to the wall (51, 52) of the transport channel (50) the contact surface (31) of the first cleaning member (30) is at least by 30% greater than the contact surface of the second cleaning member (20) at the same point of the transport channel, preferably the contact surface (31) is by 100% greater than the contact surface of the second cleaning member (20).

7. The device as in claim 3 characterised in that the core of the first cleaning member (30) is made of a material selected from a group comprising of metals, plastics, and wood.

8. The device as in claim 4 characterised in that a cleaning member (30) is filled with an amorphous material selected from a group comprising of granules, powders, gels, and liquids.

9. The device as in claim 1 characterised in that the first and second cleaning members (20, 30) are alternately connected, along the direction of transport, one after another, by means of a connecting member (40) so that they can deflect in at least one direction relative to one other.

10. The device as in claim 1 characterised in that extreme members are the second cleaning members (20).

11. The device as in claim 1 characterised in that first and second cleaning members (20, 30) are separated by a distance piece (48).

12. The device as in claim 1 characterised in that extreme second cleaning members (20) are in addition provided with detection markers (26).

13. The device as in claim 1 characterised by being provided in addition with an elastic member (45) which cooperates with a connecting member (40) so that it reduces the stresses of a connecting member (40).
